(19) United States
(12) Patent Application Publication
(10) Pub. No.: US 2012/0293057 A1
(43) Pub. Date: Nov. 22, 2012

(54) LIGHTING APPARATUS

(76) Inventors: Shoji Yamamoto, Osaka-shi (JP); Hideyuki Akao, Osaka-shi (JP)

(21) Appl. No.: 13/522,153

(22) PCT Filed: Jan. 12, 2011
(86) PCT No.: PCT/JP2011/050355

§ 371 Date: Jul. 13, 2012

(51) Int. Cl. F21V 29/00

(52) U.S. Cl. 313/45

(57) ABSTRACT

The lighting apparatus according to the present invention includes a thermal source such as a light source or a power supply unit and a heat releasing portion for releasing heat from the thermal source, and further includes the first heat radiation film formed by applying a coating material containing a heat radiating material on the surface of the heat releasing portion and curing the material. Since the first heat radiation film is formed by curing the material containing a heat radiating material, heat emittance by infrared is improved compared to the case with a heat radiation film formed by anode oxide coating (alumite treatment), thereby enhancing the heat releasing performance while maintaining the heat releasing performance by heat radiation for a long period of time because of the high resistance to damages.

### BACKGROUND

1. Technical Field

The present invention relates to a lighting apparatus including a heat releasing portion for releasing heat from a thermal source such as a light source or a power supply unit.

2. Description of Related Art

A lighting apparatus generally contains a heat generating member (thermal source) such as a light source, a power supply circuit component or the like, and needs to be configured to suppress a rise in temperature of the heat generating member so as to secure performance of the heat generating member included therein while suppressing a rise in temperature on the outer surface of the lighting apparatus for safety reasons. In particular, a lighting apparatus using a light-emitting diode (hereinafter referred to as LED) as a light source may have such a problem that the rise in temperature of LED deteriorates the longevity characteristic of LED while lowering the light-emitting efficiency, resulting in reduction in the amount of the light required. Thus, it is necessary for the lighting apparatus to have a structure with an enhanced heat releasing performance in order to suppress the rise in temperature of LED. To address such a problem, a lighting apparatus has conventionally been proposed, which utilizes convection flow of the outside air so as to discharge heat generated by a heat generating member to the air outside the lighting apparatus.

Such a lighting apparatus that uses the convection flow of the air for heat releasing, however, has a risk of failing in releasing of enough heat by the convection flow when, for example, the lighting apparatus is recessed into the ceiling like a downlight. In such a case, in order to enhance the heat releasing performance, a heat releasing portion may be configured so as to help thermal radiation (radiation of electromagnetic wave from an object which is excited by heat energy) instead of heat releasing by the convection flow (see Patent Document 1, for example).

A heat sink disclosed in Patent Document 1 includes a fin and a thermally-conductive board provided with the fin, which discharge heat from the board. In Patent Document 1, for enhancing the heat releasing performance, anodic oxide coating (alumite treatment) is applied to metal wire forming the fin in the heat sink in order to form a coating film with heat radiating property.
Patent Document 1: Japanese Patent Application Laid-Open No. 2008-98591

### SUMMARY OF THE INVENTION

The thermally-conductive coating film formed on the surface of the base of the heat sink as described above can help release heat by thermal radiation. The coating film formed by anode oxide coating (alumite treatment), however, presents insufficient heat radiation with infrared. Furthermore, the coating film may be peeled off from the heat sink because it cannot bear the prolonged use in the case where a longlife light source such as LED is used.

The present invention has been contrived in view of the above circumstances. An object of the invention is to provide a lighting apparatus that can achieve infrared thermal radiation to enhance heat radiation performance and that includes a heat releasing portion which can maintain the heat releasing performance for a long period of time.

A lighting apparatus according to the present invention includes: a thermal source such as a light source or a power supply unit; and a heat releasing portion for releasing heat from the thermal source, and is characterized in that a first heat radiation film is formed on a surface of the heat releasing portion by applying and then curing a coating material containing a heat radiating material.

According to the present invention, as the heat releasing portion has the first heat radiation film formed by applying the coating material containing the heat radiating material such as metal oxide powder and then curing the material, the thermal radiation by infrared can be enhanced and the heat releasing performance can be improved compared to the case with the heat radiation film formed by the anode oxide coating (alumite treatment). Moreover, since the first heat radiation film is formed by curing the coating material, it is more resistant to damage compared to the case with the anode oxide coating (alumite treatment) only. Thus, heat releasing performance by thermal radiation can be maintained for a long period of time.

The lighting apparatus according to the present invention is characterized in that the heat radiating material is an aluminum oxide, and the first heat radiation film is a ceramic film formed by applying a coating material containing the heat radiating material and then sintering the coating material.

According to the present invention, aluminum oxide is used for the heat radiating material while the coating material containing the heat radiating material is applied to the surface of the heat releasing portion and thereafter sintered to form the ceramic film. Thus, the heat radiation by infrared can be enhanced and the heat releasing performance can be improved compared to the case with the heat radiation film formed by anode oxide coating (alumite treatment).

The lighting apparatus according to the present invention is characterized in that a second heat radiation film is formed on a surface of the first heat radiation film by applying and then curing a coating material containing a heat radiating material having a thermal emittance different from a thermal emittance of the heat radiating material contained in the coating material applied for the first heat radiation film.

According to the present invention, the second heat radiation film is formed on the surface of the first heat radiation film with a heat radiating material having a thermal emittance different from that of the heat radiating material used for the first heat radiation film. This can attain different infrared wavelength ranges and thus expand the range of infrared emitted from each of the heat radiation films when the heat releasing portion is at a predetermined temperature, further improving the heat releasing performance by thermal radiation compared to the case where the heat radiation film is formed with one type of heat radiating material.

The lighting apparatus according to the present invention is characterized in that the second heat radiation film is a ceramic film formed by sintering a coating material containing a titanium oxide.

According to the present invention, the ceramic film used as the first heat radiation film of aluminum oxide is formed and thereafter the ceramic film used as the second heat radiation film of titanium oxide having a thermal emittance different from that of aluminum oxide is formed by separately curing them. This allows the heat radiation films to be more firmly fixed to the base compared to the case that the ceramic film is formed on the base of aluminum with the coating material including a mixture of aluminum oxide and titanium oxide.

The lighting apparatus according to the present invention is characterized in that the first heat radiation film is formed to have a thickness in a range approximately between 3 μm and 10 μm.

According to the present invention, the thickness of the first heat radiation film has a thickness suitable for infrared radiation in the case where the lighting apparatus is used in a temperature range of 100° C. or lower, achieving a higher infrared emittance from the heat releasing portion used in such a temperature range and thus improving the heat releasing performance.

The lighting apparatus according to the present invention is characterized in that the heat releasing portion has a base made of aluminum, and an aluminum oxide film is formed by oxidizing the surface of the base before the first heat radiation film is formed.

According to the present invention, the aluminum oxide film is formed on the surface of the base made of aluminum and thereafter the ceramic film is formed by applying the coating material containing aluminum oxide of the same type with high affinity. Thus, the ceramic film can more firmly be fixed to the aluminum oxide film, improving the intensity of the coating film and preventing the heat radiation film from peeling off.

According to the present invention, the heat radiation performance of the heat releasing portion in the lighting apparatus can be enhanced and the heat releasing performance can be improved while the heat releasing performance by thermal radiation can be maintained for a long period of time.

### BRIEF DESCRIPTION OF THE SEVERAL VIEWS OF THE DRAWINGS

FIG. 1 is a schematic view illustrating the appearance of a lighting apparatus according to an embodiment of the invention;

FIG. 2 is a schematic exploded perspective view of the lighting apparatus according to an embodiment of the invention;

FIG. 3 is a schematic vertical section view of the lighting apparatus according to an embodiment of the invention;

FIG. 4 is a schematic plan view illustrating a main part of the lighting apparatus according to an embodiment of the invention; and

FIG. 5 is a schematic section view illustrating an enlarged part around a surface of a heat releasing portion according to an embodiment of the invention.

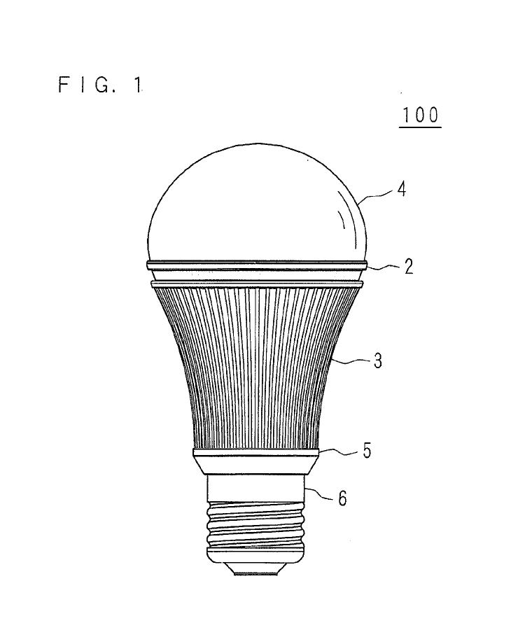

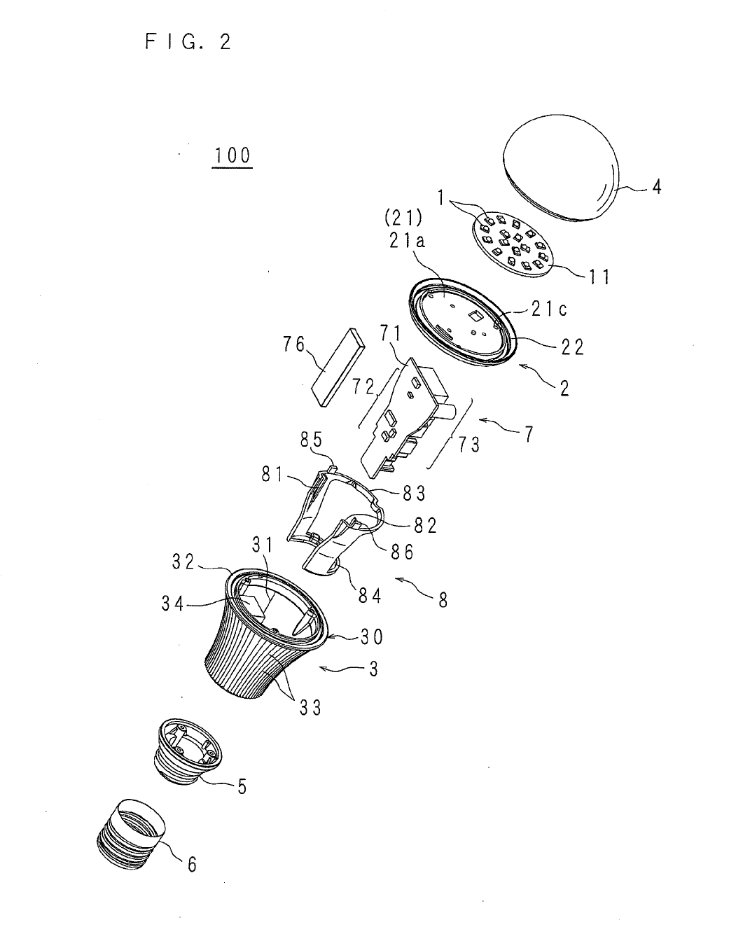

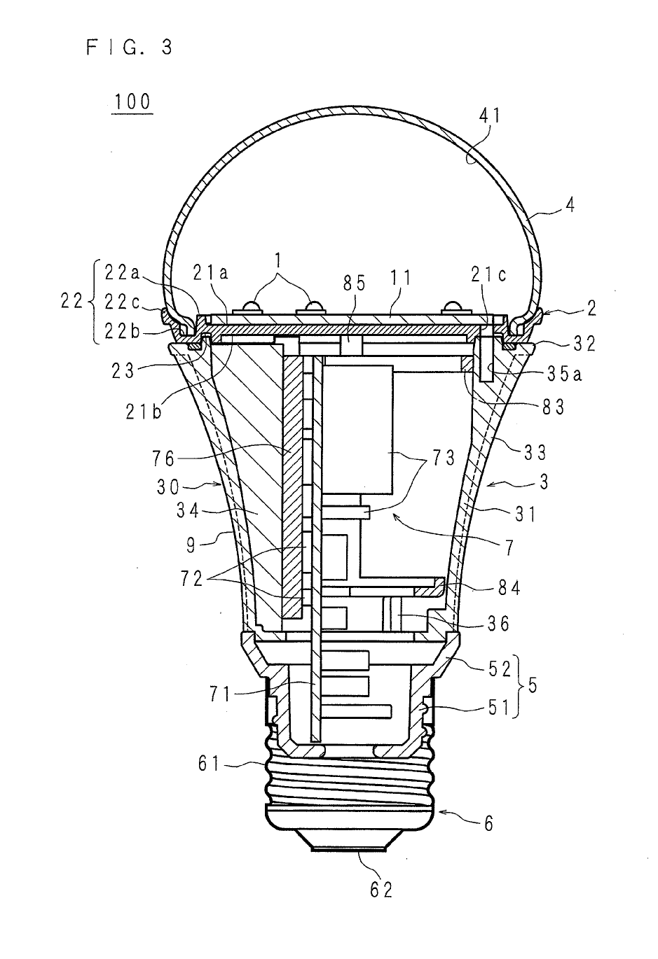

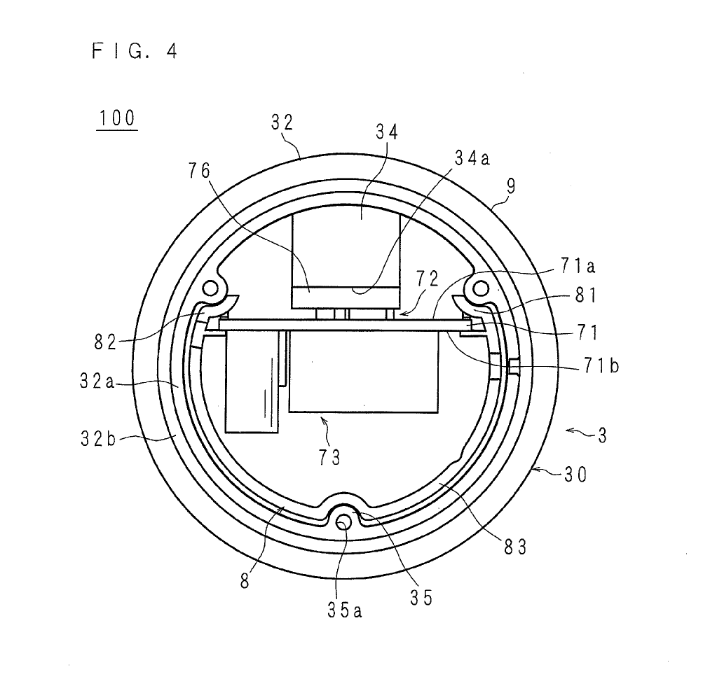

The present invention will specifically be described below with an example of a lighting apparatus of a light bulb type in reference to the drawings illustrating an embodiment thereof. FIG. 1 is a schematic view illustrating the appearance of a lighting apparatus 100 according to an embodiment of the invention. FIG. 2 is a schematic exploded perspective view of the lighting apparatus 100 according to an embodiment of the invention. FIG. 3 is a schematic vertical section view of the lighting apparatus 100 according to an embodiment of the invention. FIG. 4 is a schematic plan view illustrating a main part of the lighting apparatus 100 according to an embodiment of the invention.

The reference number 1 in the drawings denotes LED used as a light source. The LED 1 corresponds to, for example, a surface-mounted LED including LED elements, sealing resin which seals the LED elements and includes scattered fluorescence substances, an input terminal and an output terminal. Plural LEDs 1 are mounted on one surface of a mounting substrate 11 having the shape of a circular disc.

The mounting substrate 11 on which LEDs 1, 1, . . . are mounted is fixed to a heat releasing plate 2 at another surface on which no LEDs are mounted. The heat releasing plate 2 is made of metal such as aluminum and is provided with a fixing plate portion 21 having a shape of a circular disk with one surface 21a being fixed to the mounting substrate 11. An attachment portion 22 to which a cover, which will be described later, is to be attached is provided on the rim at the side of one surface 21a of the fixing plate portion 21.

The attachment portion 22 is configured to include an annular protrusion 22a standing on the outer rim of the fixing plate portion 21, an annular concave 22b formed to be continuing to the protrusion 22a and aligned concentrically with the fixing plate portion 21, and an annular convex 22c protruding in the same direction as the protrusion 22a. Note that the surface of the convex 22c on the protruding side is so inclined that the height of the convex is increased from the inner side to the outer side so as to follow the shape of the cover.

An engagement groove 23 which is engaged with a heat releasing portion, which will be described later, is formed on the rim at the side of another surface 21b of the fixing plate portion 21 of the heat releasing plate 2. Moreover, plural screw holes 21c, 21c, . . . are formed on the rim of the fixing plate portion 21. Note that a thermally-conductive sheet or grease with high thermal conductivity is preferably interposed between the mounting substrate 11 and the heat releasing plate 2. The heat releasing plate 2 is attached to a heat releasing portion 3 at the side of another surface 21b.

The heat releasing portion 3 is configured including a base 30 made of thermally-conductive material such as metal, and a heat radiation film 9 which is formed on the surface of the base 30 and has a high thermal radiation performance. In the present embodiment, the base 30 is made of aluminum. The base 30 is provided with a cylindrical heat radiation tube 31. The heat radiation tube 31 is gradually increased in its diameter from one end in the longitudinal direction to the other end, around which a flange 32 is formed. At the inner circumference on one surface of the flange 32, an annular engaging convex 32a is formed, which is engaged with the engagement groove 23 of the heat releasing plate 2. An annular concave 32b concentrically aligned with the heat radiation tube 31 is formed on the above-described one surface of the flange 32.

Furthermore, plural fins 33, 33, . . . , which are formed to protrude outward in the radial direction along the longitudinal direction of the heat radiation tube 31, are arranged at approximately equal intervals in the circumferential direction around the outer circumferential surface of the heat radiation tube 31. One end of each of fins 33, 33, . . . in the longitudinal direction continues to the flange 32.

The heat radiation tube 31 has an extending portion 34 extending inward in the radial direction from a part of the inner circumferential surface of the heat radiation tube 31. The extending portion 34 is made of metal such as aluminum and is formed to have an appropriate length along the longitudinal direction of the heat radiation tube 31. The horizontal section of the extending portion 34 has a rectangular shape as illustrated in FIG. 4. An extension end surface 34a of the extending portion 34 is formed on a planar surface facing the center line of the heat radiation tube 31 so as to be in approximately parallel with a power supply circuit substrate of a power supply unit, which will be described later. The power supply unit which is a thermal source is thermally connected to the heat releasing portion 3 at the extension end surface 34a, so that the extending portion 34 functions as a heat transfer portion for transferring heat from the power supply unit to a heat radiator. Note that the extending portion 34 may be integrally formed with the heat radiation tube 31 or may be formed separately from and fixed to the heat radiation tube 31 by adhesive or the like.

Plural boss portions 35 each having a screw hole 35a are arranged inside the flange 32 of the heat radiation tube 31. The heat releasing plate 2 is attached to the heat releasing portion 3 by fixing the heat releasing plate 2 to the flange 32 with screws while the screw holes 21c, 21c, . . . are aligned with the screw holes 35a, 35a, . . . . Thus, the mounting substrate 11 on which the LEDs 1, 1, . . . are mounted is fixed to the heat releasing portion 3 with the heat releasing plate 2 interposed in between. Note that a waterproof gasket fits in the concave 32b of the flange 32 of the heat releasing portion 3, which can make the heat releasing plate 2 closely adhered to the flange 32 and can prevent water drops from entering inside. The power supply unit described later is housed inside the heat releasing portion 3.

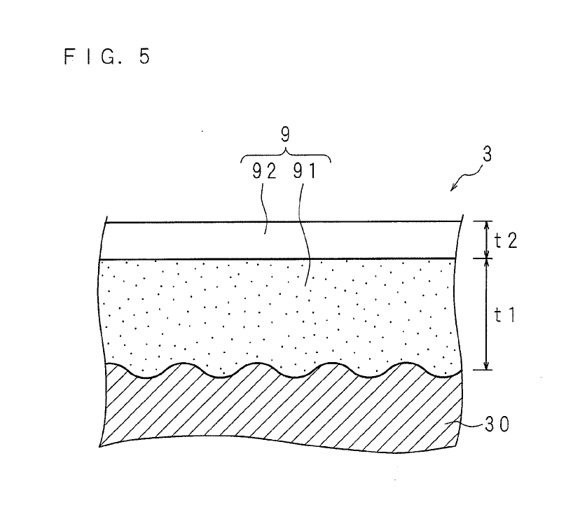

The heat radiation film 9 is formed on the outer surface (surface touching the air around the lighting apparatus 100) of the base 30 configured as described above. FIG. 5 is a schematic section view illustrating an enlarged part around a surface of the heat releasing portion 3 according to an embodiment of the invention.

The heat radiation film 9 includes a ceramic film 91 having a thickness t1 as the first heat radiation film formed on the surface of the base 30 of the heat releasing portion 3, and a ceramic film 92 having a thickness t2 as the second heat radiation film formed on the surface of the ceramic film 91. The ceramic film 91 is formed by applying a coating material including a heat radiating material with high infrared thermal emittance on the surface of the base 30 and thereafter curing the material. Moreover, the ceramic film 92 is formed by first forming the ceramic film 91 on the surface of the base 30, further applying a coating material including a heat radiating material on the surface of the ceramic film 91 and then curing the material. In the present embodiment, therefore, the first ceramic film 91 and the second ceramic film 92 are sequentially formed on the surface of the base 30 by two procedures.

The coating material used to form the ceramic film 91 includes a heat radiating material and a binder for holding the heat radiating material, the binder serving to diffuse and hold the heat radiating material such as pulverized metal oxide power. In the present embodiment, an aluminum oxide which is a metal oxide is used as the heat radiating material included in the coating material for the ceramic film 91, while silicone resin is used as the binder. Note that the heat radiating material may be any material having high infrared emittance, and thus metal oxide such as titanium oxide or silica dioxide, or pigment such as carbon black may also be used. Furthermore, the binder is not limited to silicone resin but may be any material having high resistance to discoloration including yellow discoloration caused by heat or to aging deterioration. Thus, a resin material such as acrylic resin, urethane resin, polyester resin or fluorine resin may also be used.

The thickness t1 of the ceramic film 91 is preferably in the range from 3 to 10 (μm). When used for the heat releasing portion in the lighting apparatus as in the present embodiment, the LED 1 which is a main thermal source may be set to have temperature of 100° C. or lower in order to prevent the LED element from deteriorating due to heat. The wavelength range of the infrared radiated at 100° C. or lower from the ceramic film 91 made of aluminum oxide is in the range from 2 to 10 (μm). Moreover, the thickness of the ceramic film 91 may preferably be 3 (μm) or thicker, since the amount of heat radiated by infrared is reduced if the ceramic film 91 is thin. When used under the temperature of 100° C. or lower, therefore, it is suitable for the film to have a thickness in the range from 3 to 10 (μm), more preferably, approximately 10 (μm). In the present embodiment, t1=10 (μm) is employed.

The ceramic film 92 is formed by applying a coating material containing a heat radiating material with a thermal emittance different from the thermal emittance of the aluminum oxide used as the heat radiating material for the ceramic film 91, and thereafter curing the material. The coating material used for the ceramic film 92 is, as with the coating material used for the ceramic film 91, includes a heat radiating material and a binder for holding the heat radiating material. In the present embodiment, titanium oxide which is a metal oxide is used as the heat radiating material contained in the coating material for the ceramic film 92, while silicone resin is used for the binder.

Note that the heat radiating material contained in the coating material for the ceramic film 92 is not limited to the titanium oxide, but may be any heat radiating material with a thermal emittance different from the thermal emittance for the aluminum oxide used as the heat radiating material for the ceramic film 91. Thus, metal oxide having a thermal emittance different from the aluminum oxide or a pigment such as carbon black may also be used. Moreover, the binder is not limited to the silicone resin, but may be any material which has high resistance to discoloration including yellow discoloration caused by heat or to aging deterioration and which can hold the heat radiating material for a long period of time.

The thermal emittance here means a ratio of an amount of energy emitted from the surface of a substance with a certain temperature to an amount of energy emitted from a black body (hypothetical object which absorbs 100% of the energy applied by radiation) with the same temperature, which achieves a higher heat radiation performance as the ratio is closer to 1.

Moreover, in the present embodiment, titanium oxide is used as the heat radiating material contained in the coating material for the ceramic film 92 which is the second heat radiation film located closer to the outside among the ceramic heat radiation films of two layers formed on the surface of the heat releasing portion 3, in order to make the appearance of the lighting apparatus white. Furthermore, when the thickness of the film is represented by t2=3 (μm), the ceramic film 91 which serves as a foundation of the ceramic film 92 may be completely covered and thus the surface of the heat releasing portion 3 can be made white without mottles, improving the aesthetic appearance. Moreover, the titanium oxide has a catalytic effect for activating thermal polarization of aluminum oxide, and works to promote polarization by oscillation of heat and to further absorb heat by a resonance of the generated wavelength. Accordingly, the thermal emittance of infrared on the short wavelength side can be improved even at 100° C. or lower, though the thermal emittance on the short wavelength side is generally reduced as the temperature is lowered.

Next, a method of manufacturing the heat releasing portion 3 will be described, in which the heat radiation film 9 is formed at the base 30 of the heat releasing portion 3. First, the surface of the base 30 in the heat releasing portion 3 is roughened as shown in FIG. 5. The roughening is performed by, for example, blasting the surface with sand to which a catalyst is added for accelerating oxidation of aluminum. As a result, a thin film of aluminum oxide is formed on the surface of the base 30. Next, after washing and drying, a coating material containing aluminum oxide as a heat radiating material is applied to the film, as described earlier. Subsequently, sintering is performed at a temperature of 150 to 180° C., to cure the coating material and to thus form the ceramic film 91.

Furthermore, a coating material containing titanium oxide is applied to the surface of the ceramic film 91 as the heat radiating material, as described earlier. Thereafter, the ceramic film 91 is sintered again at a temperature in the range of 150 to 180° C., to cure the coating material and to thus form the ceramic film 92. Though each of the ceramic film 91 and the ceramic film 92 is sintered to be cured in the present embodiment, they may alternatively be pressed and cured by applying pressure after the coating material is applied.

Since the ceramic film 91 and the ceramic film 92 are formed by sintering and curing the material containing pulverized heat radiating material, the pulverized heat releasing material becomes a ceramic film having a dense molecular structure. This can improve heat emittance by infrared and increase the heat releasing performance, compared to the case where only the anode oxide coating (alumite treatment) is performed without the curing procedure. Furthermore, the heat radiation film 9 formed by curing the coating material is more resistant to a damage compared to the case where only an anode oxide coating (alumite treatment) is performed, and thus can maintain a heat releasing performance by thermal radiation for a long period of time.

Accordingly, the heat releasing portion 3 in which the heat radiation film 9 is formed on the base 30 is easier to radiate infrared at the heat radiation film 9, achieving an efficient heat releasing effect by heat radiation in addition to heat release using the convection flow. This allows the heat transferred from a heat generator such as LED 1 or the power supply unit 7 to be efficiently discharged to the outside.

Moreover, an experiment by the inventors confirmed that the heat radiation is most efficiently performed when the ratio t1:t2 of the first heat radiation film of the ceramic film 91 to the second heat radiation film of the ceramic film 92 is made to be 3:1 while the ceramic film 91 is formed with aluminum oxide and the ceramic film 92 is formed with titanium oxide. Since t1=10 (μm) and t2=3 (μm) are satisfied in the present embodiment, the heat radiation film 9 is formed at a ratio of film thicknesses that can achieve efficient heat radiation.

Furthermore, the ceramic films 91 and 92 formed as the heat radiation films with heat radiating materials having different thermal emittances can obtain different wavelength ranges of infrared emitted from the heat radiation films when the heat releasing portion 3 is at a predetermined temperature, the wavelength range can be wider. This further improves the performance of heat radiation compared to the case where the heat radiation film 9 is formed with one type of heat radiating material. Even when the heat radiation film 9 is formed with one type of heat radiating material, the heat releasing performance by heat radiation is improved compared to the case where the anode oxide coating (alumite treatment) is used to form the heat radiation film 9. In other words, even in the case where only the ceramic films 91 or 92 is formed as the heat radiation film 9, the heat releasing performance by heat radiation can be enhanced. For example, only a ceramic film of titanium oxide may be formed after forming an aluminum oxide film by roughening the surface of the base 30 with oxidation catalyst and abrasive particles such as sand. This facilitates the formation of the aluminum oxide film and improves heat transfer to the ceramic film of titanium oxide, since the aluminum on the base 30 is used to form the aluminum oxide film.

In addition, after forming an aluminum oxide film by roughening the surface of the base 30 of aluminum with an oxide catalyst, a coating material containing aluminum oxide of the same type having high affinity may be applied to form the ceramic film 91 in order to enhance the adherence of the ceramic film 91 to the aluminum oxide film and the intensity of the coating film, and to prevent the heat radiation film 9 from peeling off.

Compared to the case where the ceramic film is formed by applying a coating material containing the mixture of aluminum oxide and titanium oxide on the base of aluminum, the heat radiation film 9 can be more firmly fixed to the base 30 by once forming an aluminum film on the base of aluminum and then forming thereon the ceramic film 91 of aluminum oxide and the ceramic film 92 of titanium oxide that are separately cured.

A translucent cover 4 is attached to the flange 32 of the heat releasing portion 3 so as to enclose the light-emitting side of the LEDs 1, 1, . . . . The cover 4 is made of opalescent glass having a semispherical shape.

An anti-scattering film 41 for preventing debris from scattering when the cover 4 is broken is formed across the substantially entire surface of an inner surface 4a of the cover 4. The anti-scattering film 41 is formed by applying a coating material, which includes a film base material made of resin containing silicone rubber and an addition of a diffusing agent for diffusing light, and solidifying the coating material. The diffusing agent may preferably, for example, have a crystal structure and an optical property with a high refractive index, a low optical absorbance and a high light scattering intensity. Examples of the diffusing agent include barium titanate, titanium oxide, aluminum oxide, silicon oxide, calcium carbonate and silicon dioxide.

Thus configured cover 4 is attached to the concave 22b of the heat releasing plate 2 at the periphery on the opening side by using adhesives, etc. Such a configuration allows the light from the LEDs 1, 1, . . . to enter the anti-scattering film 41 formed on the inner surface of the cover 4. The entered light is diffused by the diffusing agent 41b in the anti-scattering film 41 while penetrating therethrough, and emits to the outside through the cover 4. Such a simple configuration can widen the distribution range of light emitted from the LEDs 1, 1, . . . , each of which is a light source having a strong light directivity.

A cap 6 is provided on the opposite side of the flange 32 of the heat radiation tube 31 at the heat releasing portion 3 with a connector 5 interposed in between. The connector 5 has the shape of a closed bottom cylinder, and includes a cap holding tube 51 for holding the cap 6 as well as a connecting portion 52 which continues to the cap holding tube 51 and is connected to the heat releasing portion 3. The cap holding portion 51 has an opening for wiring at the bottom and is threaded on its outer circumference for threaded connection with the cap 6. The cap holding tube 51 and connecting portion 52 are, for example, made of an electrically insulating material such as resin, and are integrally molded. The connector 5 is integrated with the heat releasing portion 3 by fixing the connecting portion 52 side with a screw to the opposite side of the flange 32 of the heat radiation tube 31 in the heat releasing portion 3 while aligning their screw holes with each other.

The cap 6 has the shape of a closed bottom cylinder and includes one pole terminal 61 formed of a cylindrical portion threaded to be screwed into a socket for a light bulb, and another pole terminal 62 protruding from the bottom surface of the cap 6. The pole terminals 61 and 62 are insulated from each other. Note that the cylindrical portion of the cap 6 is formed to have the same appearance as, for example, that of a screw cap of E17 or E26. The cap 6 is integrated with the connector 5 by inserting the cap holding portion 51 of the connector 5 into the cap 6 to screw them together.

A cavity formed by thus integrated heat releasing plate 2, heat releasing portion 3 and connector 5 houses, for example, a power supply unit 7 for supplying the LED 1, 1, . . . with electric power of predetermined voltage and current through the wiring, as well as a holder 8 for holding the power supply unit 7 in the cavity.

The power supply unit 7 includes a power supply circuit board 71 having the shape in accordance with the vertical section of the housing cavity and plural circuit components mounted on the power supply circuit board 71. The power supply circuit board 71 is provided with a heat generating member 72 on one surface 71a of the power supply circuit board, which is a circuit component with a larger amount of heat generated by supplied current compared to a circuit component 73 mounted on another surface 71b. Examples of the heat generating member 72 include a bridge diode which full-wave rectifies alternating current supplied from an external alternating-current (AC) source, a transformer for transforming the power supply voltage after rectification to a predetermined voltage, and a diode, IC or the like connected to the primary or secondary side of the transformer. Note that a glass epoxy board, a paper phenol board or the like may be used, for example, as the power supply circuit board 71.

The holder 8 for holding the power supply unit 7 is, for example, made of an electrically-insulating material such as resin and is formed to have a shape which can be inserted into the heat radiation tube 31. The holder 8 includes: clamp portions 81, 82 for grasping the power supply circuit board 71 of the power supply unit 7 between them; semiannular frames 83, 84 arranged on the side of the heat releasing plate 2 and on the side of the cap 6, respectively, and each having an outer diameter somewhat smaller than the inner diameter of the heat radiation tube 31; and protrusions 85, 86 arranged at the frame 83 on the heat releasing plate 2 side so as to protrude toward another surface 21b of the heat releasing plate 2. Each of the clamp portions 81, 82 includes a contact piece which is in contact with a boss portion 35 of the heat radiation tube 31 and an opposite piece opposing to and separated from the contact piece by approximately the same distance as the thickness of the power circuit board 71. The power supply circuit board 71 is sandwiched between the contact piece and the opposite piece.

The holder 8 is inserted into the heat radiation tube 31 of the heat releasing portion 3 from the side of the frame 84. The contact piece for each of the clamp portions 81, 82 touches the boss portion 35 of the heat radiation tube 31 to position the holder 8 with respect to the circumferential direction of the heat radiation tube 31. Moreover, the holder 8 is arranged at one end (the side of the cap 6) of the heat radiation tube 31 of the heat releasing portion 3, and is positioned with respect to the longitudinal direction of the heat radiation tube 31 by a support convex 36 for supporting the holder 8 at the frame 84 and the protrusions 85, 86 provided on the side of the heat releasing plate 2.

By the holder 8 inserted into and arranged inside the heat releasing portion 3, the power supply unit 7 is attached inside the connector 5, while the power supply circuit board 71 is arranged substantially in parallel with a protruding end surface 34a of the protrusion 34 and the heat generating member 72 mounted on one surface 71a of the power supply circuit board 71 is in close contact with the protruding end surface 34a. A thermal conduction sheet 76 having the shape of a rectangular plate is interposed between one surface 71a of the power supply circuit board 71 and the protruding end surface 34a. The dimension and arrangement of the thermal conduction sheet 76 are appropriately determined in accordance with the arrangement of the heat generating member 72. For the thermal conduction sheet 76, a thermal conductor with an insulating property, for example a silicone rubber having a low degree of hardness and a high flame resistance, is used.

The power supply unit 7 is electrically connected with one pole terminal 61 and other pole terminal 62 of the cap 6 through an electrical wire (not shown). Moreover, the power supply unit 7 is electrically connected to the LED 1, 1, . . . at the connector through an electrical wire (not shown). Note that a pin plug may alternatively be used for the electrical connection instead of the electrical wire.

The lighting apparatus 100 configured as above is connected to an external AC power source by screwing the cap 6 into a socket for a light bulb. In such a state, the power is input to supply alternating current to the power supply unit 7 through the cap 6. The power supply unit 7 supplies power of predetermined voltage and current to the LEDs 1, 1, . . . to turn on the LEDs 1, 1, . . . .

The lighting up of the LEDs 1, 1, . . . causes mainly the LEDs 1, 1, . . . and the heat generating member 72 of the power supply unit 7 to generate heat. The heat from the LEDs 1, 1, . . . is transferred to the heat releasing plate 2 and heat releasing portion 3, and is released to the air outside the lighting apparatus 100 from the heat releasing plate 2 and heat releasing portion 3. The heat from the heat generating member 72 of the power supply unit 7 is, on the other hand, transferred mainly to the heat releasing portion 3, and is released therefrom to the air outside the lighting apparatus 100. The heat is thus released because it is transferred to the air around the lighting apparatus 100 by natural convection and also by heat radiation.

The lighting apparatus 100 according to the present embodiment includes the ceramic film 91 containing aluminum oxide at the base 30 of the heat releasing portion 30. Since the aluminum oxide is sintered as the ceramic film 91 to have a dense structure, it is possible easily to radiate infrared, to improve the heat radiation performance and also to improve the heat releasing performance of the heat releasing portion 3. Moreover, the ceramic film 92 is formed on the base 30 of the heat releasing portion 3, the ceramic film 92 being formed with a coating material containing a material having a heat emittance different from that of the heat radiating material contained in the coating material used for the ceramic film 91. This can widen the wavelength range in which infrared is radiated, improving the heat radiation performance and further enhancing the heat releasing performance of the heat releasing portion 3.

In addition, the surface of the base 30 made of aluminum is roughened by oxidation catalyst to form the aluminum oxide film, and then a coating material containing aluminum oxide of the same type with a high affinity is applied to the base 30 to form the ceramic film 91. This allows the ceramic film 91 to be more firmly fixed to the aluminum oxide film for improving the intensity of the coating film, and also prevents the heat radiation film 9 from peeling off. Accordingly, even in the case with a LED lighting apparatus which is generally used for a long period of time, a high heat radiation performance can be maintained without deterioration in the heat radiation film 9.

Furthermore, since the ceramic film 91 is formed to have a thickness in the range between 3 and 10 (μm), allowing the heat releasing portion 3 to have a higher infrared emittance and improving the heat releasing performance, especially when used in a temperature range of 100° C. or lower as in the lighting apparatus.

The heat releasing portion 3 as described above can reduce the rise in temperature of the outer surface of the lighting apparatus 100 and of the LED 1.

Though the ceramic film 91 of aluminum oxide is formed on the surface of the base 30 of the heat releasing portion 3 while the ceramic film 92 of titanium oxide is formed on the surface of the ceramic film 91 in the present embodiment, it is not limited thereto. It may be possible to form a ceramic film of titanium oxide on the surface of the base and a ceramic film of aluminum oxide on the surface of the ceramic film of titanium oxide, or alternatively, only one of the ceramic films may be formed. Moreover, a heat radiating material having a thermal emittance different from those of aluminum oxide and titanium oxide may be used to form a ceramic film as the third heat radiation film for example, forming layers of several heat radiation films.

Furthermore, though the first heat radiation film 9 is formed only at the heat releasing portion 3 in the present embodiment, it is not limited thereto. The first heat radiation film 9 may more preferably be formed also on the outer surface (the surface in contact with the air around the lighting apparatus 100) of the heat releasing plate 2.

Moreover, though the base 30 of the heat releasing portion 3 is made of aluminum in the present embodiment, it is not limited thereto.

Though the LED is used as the light source in the present embodiment, it is not limited thereto. Electro Luminescence (EL) or the like may alternatively be used.

Furthermore, though the embodiment above described an example where the heat releasing portion of the present invention is applied to a lighting apparatus of a light bulb type which is to be attached to a socket for a light bulb, the heat releasing portion may also be applied to another type of lighting apparatus or a device including a heat generator other than a lighting apparatus, not limited to the lighting apparatus described here. It is also understood that the heat releasing portion of the invention may be realized in various forms within metes and bounds of the claims, or equivalence of such metes and bounds thereof.

### DESCRIPTION OF REFERENCE CODES

1 LED (light source, thermal source)
3 heat releasing portion
30 base
7 power supply unit (thermal source)
9 heat radiation film
91 ceramic film (first heat radiation film)
92 ceramic film (second heat radiation film)

1-6. (canceled)

7. A lighting apparatus, comprising:
a thermal source such as a light source or a power supply unit; and
a heat releasing portion for releasing heat from the thermal source, wherein
a first heat radiation film is formed on a surface of the heat releasing portion by applying a coating material containing a heat radiating material to the surface and then curing the coating material.

8. The lighting apparatus according to claim 7, wherein
the heat radiating material is an aluminum oxide, and
the first heat radiation film is a ceramic film formed by applying a coating material containing the heat radiating material and then sintering the coating material.

9. The lighting apparatus according to claim 7, wherein a second heat radiation film is formed on a surface of the first heat radiation film by applying and then curing a coating material containing a heat radiating material having a thermal emittance different from a thermal emittance of the heat radiating material contained in the coating material applied to the first heat radiation film.

10. The lighting apparatus according to claim 8, wherein a second heat radiation film is formed on a surface of the first heat radiation film by applying and then curing a coating material containing a heat radiating material having a thermal emittance different from a thermal emittance of the heat radiating material contained in the coating material applied to the first heat radiation film.

11. The lighting apparatus according to claim 9, wherein the second heat radiation film is a ceramic film formed by sintering a coating material containing a titanium oxide.

12. The lighting apparatus according to claim 10, wherein the second heat radiation film is a ceramic film formed by sintering a coating material containing a titanium oxide.

13. The lighting apparatus according to claim 7, wherein the first heat radiation film is formed to have a thickness in a range approximately between 3 μm and 10 μm.

14. The lighting apparatus according to claim 8, wherein the first heat radiation film is formed to have a thickness in a range approximately between 3 μm and 10 μm.

15. The lighting apparatus according to claim 9, wherein the first heat radiation film is formed to have a thickness in a range approximately between 3 μm and 10 μm.

16. The lighting apparatus according to claim 10, wherein the first heat radiation film is formed to have a thickness in a range approximately between 3 μm and 10 μm.

17. The lighting apparatus according to claim 7, wherein
the heat releasing portion has a base made of aluminum, and
an aluminum oxide film is formed by oxidizing the surface of the base before the first heat radiation film is formed.

18. The lighting apparatus according to claim 8, wherein
the heat releasing portion has a base made of aluminum, and
an aluminum oxide film is formed by oxidizing the surface of the base before the first heat radiation film is formed.

19. The lighting apparatus according to claim 9, wherein
the heat releasing portion has a base made of aluminum, and
an aluminum oxide film is formed by oxidizing the surface of the base before the first heat radiation film is formed.

20. The lighting apparatus according to claim 10, wherein
the heat releasing portion has a base made of aluminum, and
an aluminum oxide film is formed by oxidizing the surface of the base before the first heat radiation film is formed.
